(19) United States
(12) Patent Application Publication
(10) Pub. No.: US 2016/0113268 A1
(43) Pub. Date: Apr. 28, 2016

(54) METHOD OF GUIDING WILDLIFE TO A DESIRED HUNTING LOCATION

(71) Applicants: Peter William Anderson, Boonsboro, MD (US); Daniel Albert Franklin, Hagerstown, MD (US)

(72) Inventors: Peter William Anderson, Boonsboro, MD (US); Daniel Albert Franklin, Hagerstown, MD (US)

(21) Appl. No.: 14/875,817

(22) Filed: Oct. 6, 2015

Related U.S. Application Data
(60) Provisional application No. 62/066,980, filed on Oct. 22, 2014.

(51) Int. Cl. A01M 31/00

(52) U.S. Cl. CPC A01M 31/00

(57) ABSTRACT

A fencing system for hunting is provided. The fencing system includes a fencing having a length from a first end to a second end, and a height from a top end to a bottom end. At least a first cord is interwoven through apertures formed at the top end of the fencing. The first cord is interwoven along the entire length of the fencing. A first end of the first cord is secured to a first vertical support extending from the ground. A second end of the first cord is secured to a second vertical support extending from the ground. The fencing forms a barrier, changing the pathway of the hunted game.

### CROSS-REFERENCE TO RELATED APPLICATION

This application claims the benefit of priority of U.S. provisional application No. 62/066,980, filed Oct. 22, 2014, the contents of which are herein incorporated by reference.

### BACKGROUND OF THE INVENTION

The present invention relates to hunting and, more particularly, to a method of guiding wildlife to a desired hunting location.

Deer and other big game hunting is survival hunting or sport hunting, which dates back tens of thousands of years. There are numerous types of deer and other big game throughout the world that are hunted. Deer move through the forest in an unpredictable manner. Natural funnels in the forest provide predictable pathways for deer and other big game. However, natural funnels are not always located in desirable hunting locations.

As can be seen, there is a need for a method of creating unnatural funnels to increase a hunter's chance for a successful kill.

### SUMMARY OF THE INVENTION

In one aspect of the present invention, a method of guiding wildlife to a desired location comprises: providing a fencing comprising a length from a first end to a second end and a height from a top end and a bottom end; interweaving a first cord through apertures formed on the top end of the fencing along the length of the fencing; securing a first end of the first cord to a first vertical support extending from a ground; and securing a second end of the first cord to a second vertical support extending from the ground.

These and other features, aspects and advantages of the present invention will become better understood with reference to the following drawings, description and claims.

### BRIEF DESCRIPTION OF THE DRAWINGS

FIG. 1 is a front view of a section of an exemplary embodiment of the present invention;

FIG. 2 is a perspective detail view of the present invention demonstrating a securement method; and

FIG. 3 is a section detail view of an embodiment of the present invention along line 3-3 in FIG. 1 demonstrating a cord routing method.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a fencing system to direct animals to a path of travel optimal for hunters. The present invention allows hunters to create a funnel effect or pinch point in a desired hunting location, thereby changing the travel patterns of big game to a predetermined point. This enables hunters to condition the animals to move within range and thereby increase the success rate of the hunt.

The present invention includes fence material that is stretched out to produce a barrier which forces animals to adjust their travel patterns. Bungee cords may be used to secure the fence to existing trees or posts approximately 6 inches off the ground. The fence may be secured to different sized trees without damaging the trees using the adjustable bungee cords. The poly rope or cord is woven through the top of the fence and tied to the trees on opposite ends to make the top taut and providing rigidity to the fence. When properly placed, the fence causes big game to navigate around the fence while allowing small game to pass underneath. The present invention provides closer encounters with big game for hunters thereby providing better shot opportunities.

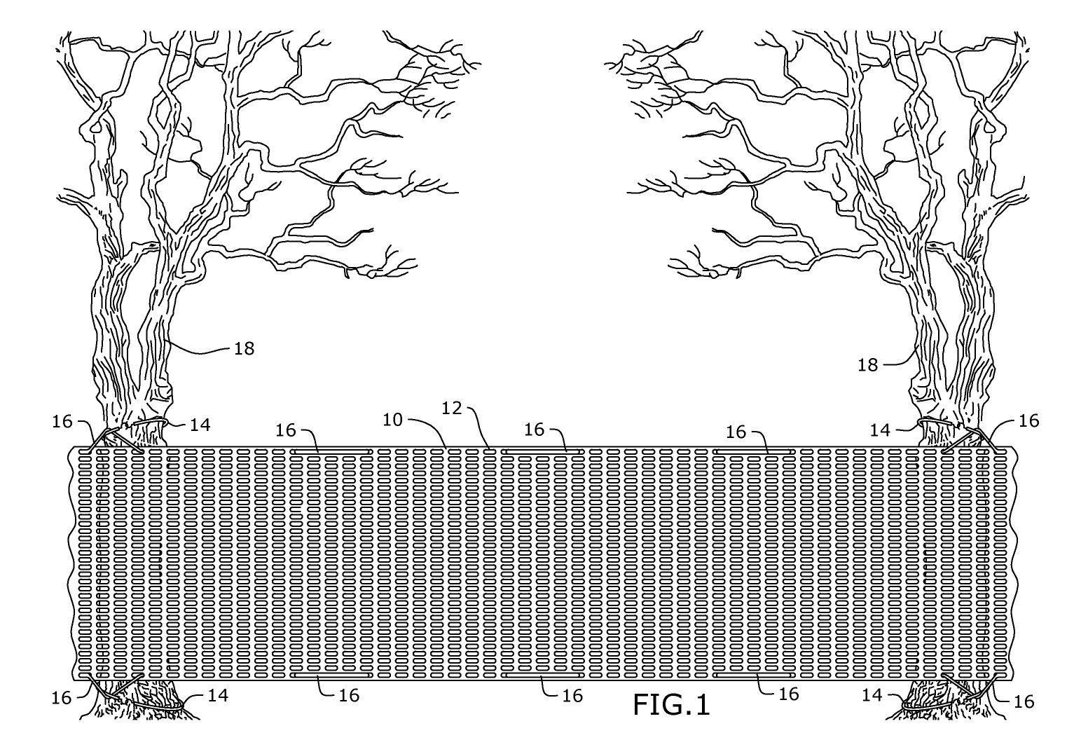

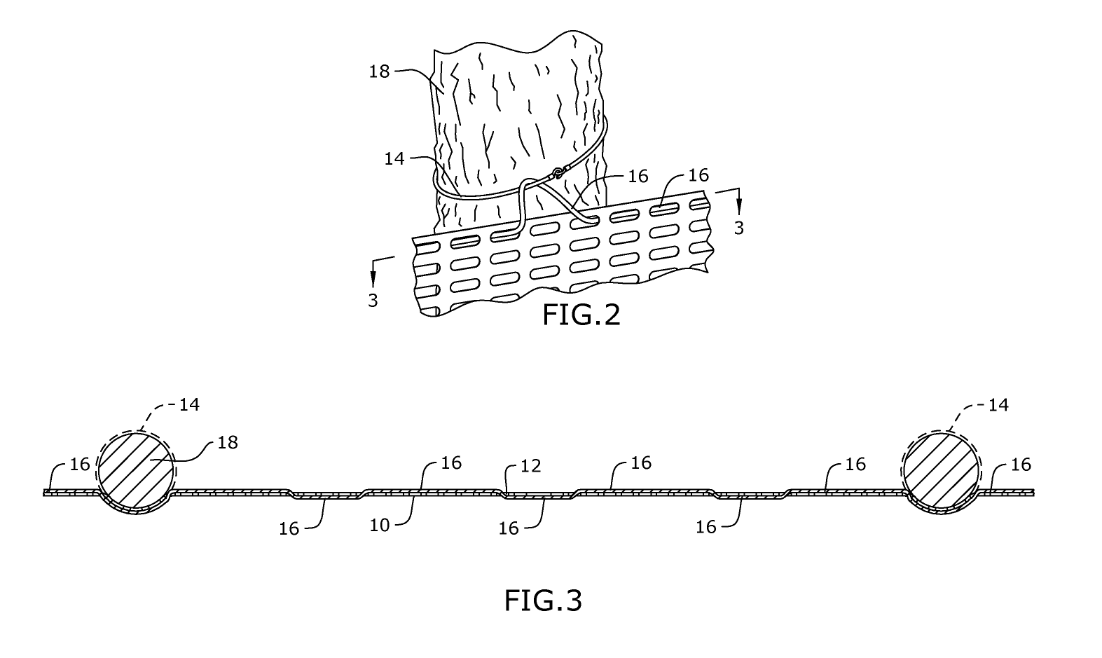

Referring to FIGS. 1 through 3, the present invention includes a fencing system. The fencing system includes a fencing 10 having a length from a first end to a second end, and a height from a top end to a bottom end. At least a first cord 16 is interwoven through apertures 12 formed at the top end of the fencing 10. The first cord 16 is interwoven along the entire length of the fencing 10. A first end of the first cord 16 is secured to a first vertical support 18 extending from the ground. A second end of the first cord 16 is secured to a second vertical support extending from the ground. The fencing 10 now forms a barrier, changing the pathway of the game.

To add additional support to the fencing 10, the present invention may include a second cord 16. The second cord 16 is interwoven through apertures 12 formed at the bottom end of the fencing 10. The second cord 16 is interwoven along the entire length of the fencing 10. A first end of the second cord 16 is secured to the first vertical support 18 extending from the ground. A second end of the second cord 16 is secured to the second vertical support extending from the ground. The first and second cords 16 may be pulled tight and secured to the vertical supports 18, thereby forming a taut fence.

The vertical supports 18 of the present invention may include trees. In certain embodiments, the present invention may include ties 14 to secure the fencing 10 to trees in between the first end and the second end of the fencing 10. The ties 14 may include stretchable bungee cords with hooks. For example, the bungee cord may be wrapped around a third support structure located in between the first and second support structure. The bungee cord may run in between the fencing 10 and the first cord 16 and the hooks of the bungee cord may hook together. A second bungee cord may be wrapped around the third support structure, run in between the fencing 10 and the second cord 16 and hook together. Therefore, the bungee cords attach a mid portion of the fencing 10 to a tree, adding additional support to the fencing 10.

The fencing 10 of the present invention may be made of a stretchable material, such as a polymer. The polymer may be plastic. A plurality of evenly spaced apertures 12 may be formed throughout the entire fencing 10. The fencing 10 may be positioned at least six inches above the ground to allow smaller animals to pass underneath the fencing 10. Further, the fencing 10 may be at least eight feet in height to prevent the deer from hopping over the fencing 10.

It should be understood, of course, that the foregoing relates to exemplary embodiments of the invention and that modifications may be made without departing from the spirit and scope of the invention as set forth in the following claims.

What is claimed is:

1. A method of guiding wildlife to a desired location comprising:
providing a fencing comprising a length from a first end to a second end and a height from a top end and a bottom end;
interweaving a first cord through apertures formed on the top end of the fencing along the length of the fencing;
securing a first end of the first cord to a first vertical support extending from a ground; and
securing a second end of the first cord to a second vertical support extending from the ground.

2. The method of claim 1, further comprising the steps of:
wrapping at least one tie around a third vertical support extending from the ground; and
securing the at least one tie to the cord in between the first end and the second end of the fencing.

3. The method of claim 2, wherein the at least one tie is a bungee cord.

4. The method of claim 2, wherein the first vertical post, the second vertical post, and the third vertical post are each a tree.

5. The method of claim 1, further comprising the steps of:
interweaving a second cord through apertures formed on the bottom end of the fencing along the length of the fencing;
securing a first end of the second cord to the first vertical support; and
securing a second end of the second cord to the second vertical support.

6. The method of claim 1, wherein the fencing comprises a stretchable polymer.

7. The method of claim 1, wherein the bottom end of the fencing is disposed at least 6 inches above the ground.

8. The method of claim 1, wherein the fencing comprises a height of at least 8 feet.
